(19) United States
(12) Patent Application Publication
(10) Pub. No.: US 2010/0001990 A1
(43) Pub. Date: Jan. 7, 2010

(54) SCAN DRIVER AND ORGANIC LIGHT EMITTING DISPLAY DEVICE USING THE SAME

(76) Inventors: Mi-Hae Kim, Suwon-si (KR); Seon-I Jeong, Suwon-si (KR)

Correspondence Address: CHRISTIE, PARKER & HALE, LLP, PO BOX 7068, PASADENA, CA, 91109-7068, US

(21) Appl. No.: 12/497,415

(22) Filed: Jul. 2, 2009

(30) Foreign Application Priority Data
Jul. 4, 2008 (KR) 10-2008-0064914

(51) Int. Cl. G09G 5/00; G09G 3/30

(52) U.S. Cl. 345/214; 345/76; 315/169.3; 345/82

(57) ABSTRACT

A scan driver for outputting scan signals in two directions and an organic light emitting display device are provided. In one embodiment, a scan driver includes a plurality of stages for outputting scan signals, wherein an n-1^{th} stage includes: a transmission gate unit for selectively outputting one of a second latch signal from an n-2^{th} stage or a second latch signal from an n^{th} stage in accordance with a first direction control signal and a second direction control signal; a latch unit for outputting a first latch signal and a second latch signal by utilizing one of a plurality of control signals and the selected second latch signal, and for transmitting the second latch signal to the n-2^{th} stage and the n^{th} stage; and an output buffer unit for outputting scan signals in accordance with other ones of the plurality of control signals and the first latch signal.

### CROSS-REFERENCE TO RELATED APPLICATIONS

This application claims priority to and the benefit of Korean Patent Application No. 10-2008-0064914, filed on Jul. 4, 2008, in the Korean Intellectual Property Office, the entire content of which is incorporated herein by reference.

### BACKGROUND

1. Field of the Invention

The present invention relates to a scan driver and an organic light emitting display device using the same.

2. Discussion of Related Art

Recently, various flat panel display devices have been developed with reduced weight and volume as compared to cathode ray tubes. Different flat panel display devices include liquid crystal display (LCD) devices, field emission display (FED) devices, plasma display panels (PDPs), and organic light emitting display devices, among others.

Of these display devices, the organic light emitting display device displays images by using organic light emitting diodes (OLEDs) to generate light through the recombination of electrons and holes.

The organic light emitting display has several advantages, such as excellent color reproducibility and a slim form factor, such that its application has been expanded to cellular phones, PDAs, MP3 players, and various other types of devices.

OLED displays can be applied to various electronic devices. In particular, when it is applied to cellular phones and camcorders, the screen of the OLED display may be inverted during operation of a cellular phone or camcorder. When the screen is inverted, if the scan driver outputs scan signals in the same direction, the upper and lower parts of the image would be reversed.

### SUMMARY OF THE INVENTION

Therefore, an aspect of an embodiment of the present invention provides a scan driver capable of outputting scan signals in two directions and an organic light emitting display device using the same.

A scan driver according to a first aspect of an embodiment of the present invention is provided, including a plurality of stages for outputting scan signals, wherein an n-1^{th} stage of the plurality of stages includes: a transmission gate unit for selectively outputting one of a second latch signal from an n-2^{th} stage of the plurality of stages or a second latch signal from an n^{th} stage of the plurality of stages in accordance with a first direction control signal and a second direction control signal; a latch unit for outputting a first latch signal and a second latch signal by utilizing one of a plurality of control signals and the selected second latch signal, and for transmitting the second latch signal to the n-2^{th} stage and the n^{th} stage; and an output buffer unit for outputting scan signals in accordance with other ones of the plurality of control signals and the first latch signal.

A scan driver according to a second aspect of an embodiment of the present invention is provided, including a plurality of stages for outputting scan signals, wherein an n-1^{th} stage of the plurality of stages includes: a transmission gate unit for selectively outputting one of a second latch signal from an n-2^{th} stage of the plurality of stages or a second latch signal from an n^{th} stage of the plurality of stages in accordance with a first direction control signal and a second direction control signal; a latch unit for outputting a first latch signal and a second latch signal by utilizing a first control signal and the selected second latch signal, and for transmitting the second latch signal to the n-2^{th} stage and the n^{th} stage; and an output buffer unit for outputting scan signals in accordance with additional control signals and the first latch signal.

An organic light emitting display device according to a third aspect of an embodiment of the present invention is provided, including: a display unit for displaying images in accordance with data signals and scan signals; a data driver for generating and outputting the data signals; a scan driver for generating and outputting the scan signals; and a controller for transmitting a plurality of control signals to the data driver and the scan driver, wherein the scan driver includes a plurality of stages for outputting the scan signals, and wherein an n-1^{th} stage of the plurality of stages includes: a transmission gate unit for selectively outputting one of a second latch signal from an n-2^{th} stage of the plurality of stages or a second latch signal from an n^{th} stage of the plurality of stages in accordance with a first direction control signal and a second direction control signal; a latch unit for outputting a first latch signal and a second latch signal by utilizing one of the plurality of control signals and the selected second latch signal, and for transmitting the second latch signal to the n-2^{th} stage and the n^{th} stage; and an output buffer unit for outputting scan signals in accordance with other ones of the plurality of control signals and the first latch signal.

An organic light emitting display device according to a fourth aspect of an embodiment of the present invention is provided including: a display unit for displaying images in accordance with data signals and scan signals; a data driver for generating and outputting the data signals; a scan driver for generating and outputting the scan signals; and a controller for transmitting control signals to the data driver and the scan driver, wherein the scan driver includes a plurality of stages for outputting the scan signals, and wherein an n-1^{th} stage of the plurality of stages includes: a transmission gate unit for selectively outputting one of a second latch signal from an n-2^{th} stage of the plurality of stages or a second latch signal from an n^{th} stage of the plurality of stages in accordance with a first direction control signal and a second direction control signal; a latch unit for outputting a first latch signal and a second latch signal by utilizing a first control signal and the selected second latch signal, and for transmitting the second latch signal to the n-2^{th} stage and the n^{th} stage; and an output buffer unit for outputting scan signals in accordance with additional control signals and the first latch signal.

With a scan driver and an organic light emitting display device according to aspects of embodiments of the present invention, the scan driver may be driven in two directions. Therefore, even when the screen is upside-down due to the rotation of the screen, the present invention can prevent the display of a reversed image.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic block diagram of an organic light emitting display device according to an embodiment of the present invention.

FIG. 2 is a circuit diagram of an embodiment of the scan driver shown in FIG. 1;

FIG. 3 is a timing diagram illustrating a forward operation of the scan driver shown in FIG. 2; and

FIG. 4 is a timing diagram illustrating a reverse operation of the scan driver shown in FIG. 2.

### DETAILED DESCRIPTION OF EXEMPLARY EMBODIMENTS

Hereinafter, certain exemplary embodiments according to the present invention will be described with reference to the accompanying drawings. Here, when a first element is described as being coupled to a second element, the first element may be directly coupled to the second element, or may be indirectly coupled to the second element via one or more additional elements. Further, some elements that are not essential to the complete understanding of the invention are omitted for clarity. Also, like reference numerals refer to like elements throughout.

Hereinafter, embodiments of the present invention will be described in more detail with reference to the accompanying drawings.

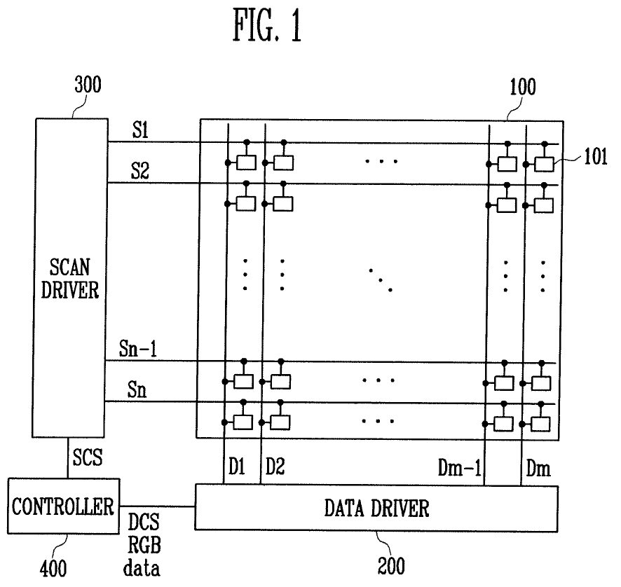

FIG. 1 is a schematic block diagram of an organic light emitting display device according to the present invention. Referring to FIG. 1, an organic light emitting display device includes a display unit 100, a data driver 200, a scan driver 300, and a controller 400.

The display unit 100 includes a plurality of pixels 101, each pixel 101 including an organic light emitting diode that emits light corresponding to a flow of current. The display unit 100 is arranged with n scan lines (S1, S2, . . . Sn-1, and Sn) in a row direction which transmit scan signals, and m data lines (D1, D2, . . . Dm-1, and Dm) in a column direction which transmit data signals.

Also, the display unit 100 is driven by receiving first power and second power from a power supply unit. Therefore, when current flows to the organic light emitting diode in accordance with the scan signals, the data signals, and the first power and the second power, the display unit 100 emits light corresponding to different amounts of current to display images.

The data driver 200 generates the data signals by using RGB data having red, blue, and green components. Also, the data driver 200 is coupled to the data lines D1, D2 . . . Dm-1, and Dm of the pixel unit to apply the generated data signals to the display unit 100.

The scan driver 300 generates the scan signals, and is coupled to the scan lines S1, S2, . . . Sn-1, and Sn to transmit the scan signals to a specific row of the display unit 100. A pixel 101 generates driving current by receiving the scan signal together with the data signal from the data driver 200, the driving current flowing to the organic light emitting diode. Also, the scan driver 300 may be driven in one of two directions. In other words, the scan driver 300 may be selectively driven in two schemes, i.e., one sequentially outputting the scan signals from a first scan line to a final scan line and the other sequentially outputting the scan signals from the final scan line to the first scan line.

The controller 400 transmits signals, such as RGB data, a data driver control signal (DSC), and a scan driver control signal (SCS). to the data driver 200 and the scan driver 300. The controller 400 controls the operations of the data driver 200 and the scan driver 300, making it possible to display the images on the display unit 100. At this time, the scan driver control signal SCS includes a direction control signal to control the bidirectional driving, and a control signal for controlling a pulse width of the scan signal.

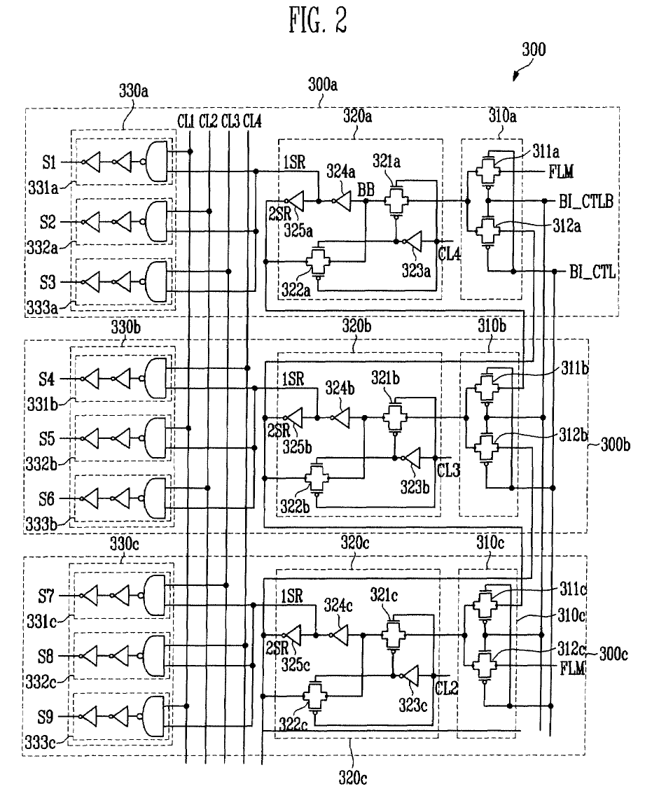

FIG. 2 is a circuit diagram of an embodiment of a scan driver, for example, the scan driver 300 described with respect to FIG. 1. Referring to FIG. 2, the scan driver 300 includes a first stage 300a that outputs a first scan signal S1, a second scan signal S2, and a third scan signal S3, a second stage 300b that outputs a fourth scan signal S4, a fifth scan signal S5, and a sixth scan signal S6, and a third stage 300c that outputs a seventh scan signal S7, an eighth scan signal S8, and a ninth scan signal S9. Each stage includes a respective transmission gate unit 310a, 310b, or 310c, a respective latch unit 320a, 320b, or 320c, and a respective output buffer unit 330a, 330b, or 330c. Each of the transmission gate units 310a, 310b, and 310c and each of the latch units 320a, 320b, and 320c are provided with a plurality of transmission gates. Each of the transmission gates includes an NMOS transistor and a PMOS transistor coupled to each other, and has a first electrode receiving a signal, a second electrode outputting a signal, a first gate of the NMOS transistor, and a second gate of the PMOS transistor.

Describing a structure of the first stage 300a, the transmission gate unit 310a includes a first transmission gate 311a and a second transmission gate 312a. A start pulse FLM is input through the first electrode of the transmission gate 311a, and a latch signal 2SR generated in the second stage 300b is transmitted through the first electrode of the second transmission gate 312a. Also, the first gate of the first transmission gate 311a and the second gate of the second transmission gate 312a are coupled to a first direction control signal BI-CTL, and the second gate of the first transmission gate 311a and the first gate of the second transmission gate 312a are coupled to a second direction control signal BI_CTLB. The second direction control signal BI_CTLB is a sub-signal of the first direction control signal BI_CTL.

The latch unit 320a includes a third transmission gate 321a, a fourth transmission gate 322a, a first inverter 323a, a second inverter 324a, and a third inverter 325a. A first gate of the third transmission gate 321a is coupled to a fourth control signal terminal CL4, whereas a second gate receives the control signal that has been transmitted through the fourth control signal terminal CL4 and inverted by the first inverter 323a. The first gate of the fourth transmission gate 322a receives the control signal that has been transmitted through the fourth control signal terminal CL4 and inverted by the first inverter 323a, whereas a second gate receives the control signal transmitted through the fourth control signal terminal CL4. The first electrode of the third transmission gate 321a is coupled to the second electrode of the first transmission gate 311a and the second transmission gate 312a of the transmission gate unit 310a. Also, the second electrode of the third transmission gate 321a is coupled to a second inverter 324a and the first electrode of the fourth transmission gate 322a. A signal output from the second inverter 324a is called a first latch signal 1SR and a signal output from a third inverter 325a is called a second latch signal 2SR. The first latch signal 1SR is transmitted to the output buffer unit 330a and the third inverter 325a. The second latch signal 2SR output from the third inverter 325a is transmitted through the second electrode of the fourth transmission gate 322a and the first transmission gate 311b of the transmission gate unit 310b of the second stage 300b. The fourth transmission gate 322a is turned-on when the third transmission gate 321a is turned-off and is coupled between the input terminal BB of the second inverter 324a and the output terminal of the third inverter 325a.

The output buffer unit 330a includes a first output stage 331a that outputs the first scan signal S1, a second output stage 332a that outputs the second scan signal S2, and a third output stage 333a that outputs the third scan signal S3, each output stage including a NAND gate and two inverters. Also, the output buffer unit 330a is coupled to the output terminal of the second inverter 324a and the first to third control signal terminals CL1, CL2, and CL3 of the first to fourth control signal terminals CL1, CL2, CL3, and CL4. Therefore, the output buffer unit 330a receives a signal transmitted through the output terminal of the second inverter 324a and the first to third control signals respectively transmitted through the first to third control signal terminals CL1, CL2, and CL3, and operates them to output the first to third scan signals S1, S2, and S3, respectively.

The structure of the output buffer unit 330a will be described in more detail. The first output stage 331a includes a first NAND gate, a fourth inverter, and a fifth inverter. One input terminal of the first NAND gate is coupled to the output terminal of the second inverter 324a of the latch unit 320a and the other thereof is coupled to the first control signal terminal CL1. The output terminal of the first NAND gate is serially coupled to the fourth inverter and the fifth inverter. Therefore, the first output stage 331a performs a NAND operation on the first control signal transmitted from the first control signal terminal CL1 and the signal transmitted from the output terminal of the second inverter 324a and inverts it twice through the fourth inverter and the fifth inverter for outputting. The output signal becomes the first scan signal S1.

The second output stage 322a includes a second NAND gate, a sixth inverter, and a seventh inverter. One input terminal of the second NAND gate is coupled to the output terminal of the second inverter 324a of the latch unit 320a, and the other thereof is coupled to the second control signal terminal CL2. The output terminal of the second NAND gate is serially coupled to the sixth inverter and the seventh inverter. Therefore, the second output stage 332a performs a NAND operation on the second control signal transmitted from the second control signal terminal CL1 and the signal transmitted from the output terminal of the second inverter 324a and inverts it twice through the sixth inverter and the seventh inverter for outputting. The output signal is the second scan signal S2.

The third output stage 333a includes a third NAND gate, an eighth inverter, and a ninth inverter. One input terminal of the third NAND gate is coupled to the output terminal of the second inverter 324a of the latch unit 320a, and the other thereof is coupled to the third control signal terminal CL3. The output terminal of the third NAND gate is serially coupled to the eighth inverter and the ninth inverter. Therefore, the third output stage 333a performs a NAND operation on the third control signal transmitted from the third control signal terminal CL3 and the signal transmitted from the output terminal of the second inverter 324a and inverts it twice through the eighth inverter and the ninth inverter for outputting. The output signal is the third scan signal S3.

The second stage 300b has substantially the same structure as the first stage 300a, but receives the second latch signal 2SR from the first stage 300a and the second latch signal 2SR from the third stage 300c at the transmission gate 310b. The transmission gate unit 310b transmits one of the second latch signal 2SR from the first stage 300a and the second latch signal 2SR from the third stage 300c to the latch unit 320b by utilizing the first direction control signal BI_CTL and the second direction control signal BI_CTLB. Also, in the latch unit 320b of the second stage 300b the third transmission gate 321b is coupled to the third control signal terminal CL3. The output buffer unit 330b of the second stage 300b is coupled to the first latch signal 1SR from the latch unit 320b and the first control signal terminal CL1, the second control signal terminal CL2, and the fourth control signal terminal CL4. The output buffer unit 330b of the second stage 300b operates the first latch signal 1SR and the control signals output from the fourth control signal terminal CL4, the first control signal terminal CL1, and the second control signal terminal CL2, respectively, to generate the fourth scan signal S4, the fifth scan signal S5, and the sixth scan signal S6.

The third stage 300c is the same structure as the first stage 300a, but receives the second latch signal 2SR from the second stage 300b and the start pulse FLM at the transmission gate unit 310c. The transmission gate unit 310c transmits one of the second latch signal 2SR from the second stage 300b and the start pulse FLM to the latch unit 320b by utilizing the first direction control signal BI_CTL and the second direction control signal BI_CTLB. Also, in the latch unit 320c of the third stage 300c, the third transmission gate 321c is coupled to the second control signal terminal CL2. The output buffer unit 330c of the third stage 300c is coupled to the first latch signal 1SR from the latch unit 320c and the third control signal terminal CL3, the fourth control signal terminal CL4, and the first control signal terminal CL1 to generate the seventh scan signal S7, the eighth scan signal S8, and the ninth scan signal S9, respectively.

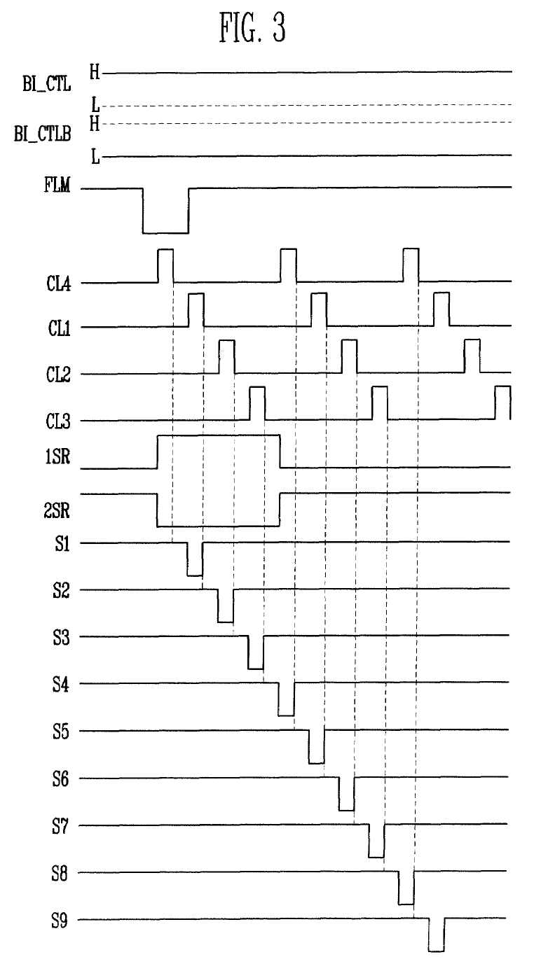

FIG. 3 is a timing chart illustrating a forward operation of the scan driver shown in FIG. 2. Referring to FIG. 3, the scan driver 300 is operated by utilizing the first direction control signal BI_CTL, the second direction control signal BI_CTLB, the start pulse FLM, the first control signal CL1, the second control signal CL2, the third control signal CL3, and the fourth control signal CL4.

When the scan driver 300 is driven in a forward direction, the first direction control signal BI_CTL becomes a high state, and the second direction control signal BI-CTLB becomes a low state. Therefore, the first transmission gate 311a of the transmission gate unit 310a becomes an on state, whereas the second transmission gate 312a becomes an off state. Therefore, the start pulse FLM is transmitted to the latch unit 320a through the first transmission gate 311a. The fourth control signal CL4, the first control signal CL1, the second control signal CL2, and the third control signal CL3 are sequentially set high.

When the fourth control signal CL4 becomes a high state, the third transmission gate 321a of the latch unit 320a becomes an on state, and the fourth transmission gate 322a becomes an off state. When the fourth control signal CL4 becomes a low state, the third transmission gate 321a becomes an off state and the fourth transmission gate 322a becomes an on state.

Therefore, when the fourth control signal CL4 becomes a high state, the start pulse FLM is transmitted to the second inverter 324a through the third transmission gate 321a. When the fourth control signal CL4 is a low state, the start pulse FLM is not transmitted to the latch unit 320a. Also, since the fourth transmission gate 322a becomes an on state, the input terminal BB of the second inverter 324a and the output terminal of the third inverter 325a are shorted by the fourth transmission gate 322a. That is, the input terminal BB of the second inverter 324a and the output terminal of the third inverter 325a have the same potential.

In other words, when the fourth control signal CL4 becomes a high state, the start pulse FLM is transmitted so that the second latch signal 2SR, in a low state, is output to the output terminal of the third inverter 325a. When the fourth control signal terminal CL4 becomes a low state, the output terminal of the third inverter 325a is coupled to the input terminal BB of the second inverter 324a by fourth the transmission gate 322a, so that the second inverter 324a is transmitted with the second latch signal 2SR in a low state. Therefore, the latch unit 320a outputs the first latch signal 1SR, in a high state, through the second inverter 324a for a period of time, and outputs the second latch signal 2SR, in a low state, through the third inverter 325a. Later, when a high fourth control signal CL4 is input again to the latch unit 320a, the start pulse FLM is in a high state. Therefore, a high signal is input to the input terminal BB of the second inverter 324a, so that the first latch signal 1SR becomes a low state, and the second latch signal 2SR becomes high state.

The first latch signal 1SR output through the second inverter 324a of the latch unit 320a is transmitted to the output buffer unit 330a, and the second latch signal 2SR output through the third inverter 325a is transmitted to the transmission gate unit 310b in the second stage 300b.

The NAND gate of the first stage 331a of the output buffer unit 330a performs the NAND operation on the first latch signal 1SR and the first control signal CL1. Therefore, when both the first latch signal 1SR and the first control signal CL1 become a high state, the first scan signal S1 is in a low state. When at least one of the first latch signal 1SR and the first control signal CL1 becomes a low state, the first scan signal S1 is in a high state. The first latch signal 1SR maintains a high state for a period of time based on the operation of the latch unit 320a. Therefore, the output buffer unit 330a outputs a low first scan signal S1 when the first control signal CL1 is high. In other words, the pulse width of the first scan signal S1 is determined by the first control signal CL1.

The second output stage 332a and the third output stage 333a of the output buffer unit 330a operate similarly to the first operation terminal 331a. At this time, since the first to the fourth control signals CL1, CL2, CL3, CL4 sequentially turn high, the second control signal CL2 becomes a high state after the first control signal CL1 and the third control signal CL3 becomes a high state after the second control signal CL2. Therefore, as the second output stage 332a and the third output stage 333a receive the second control signal CL2 and the third control signal CL3, respectively, the second scan signal S2 becomes a low state after the first scan signal S1, and the third scan signal S3 becomes a low state after the second scan signal S2. Therefore, the first scan signal S1, the second scan signal S2, and the third scan signal S3 are sequentially turned low.

The second stage 300b and the third stage 300c perform similar operations to sequentially generate and output the fourth scan signal S4, the fifth scan signal S5, the sixth scan signal S6, the seventh scan signal S7, the eighth scan signal S8, and the ninth signal S9.

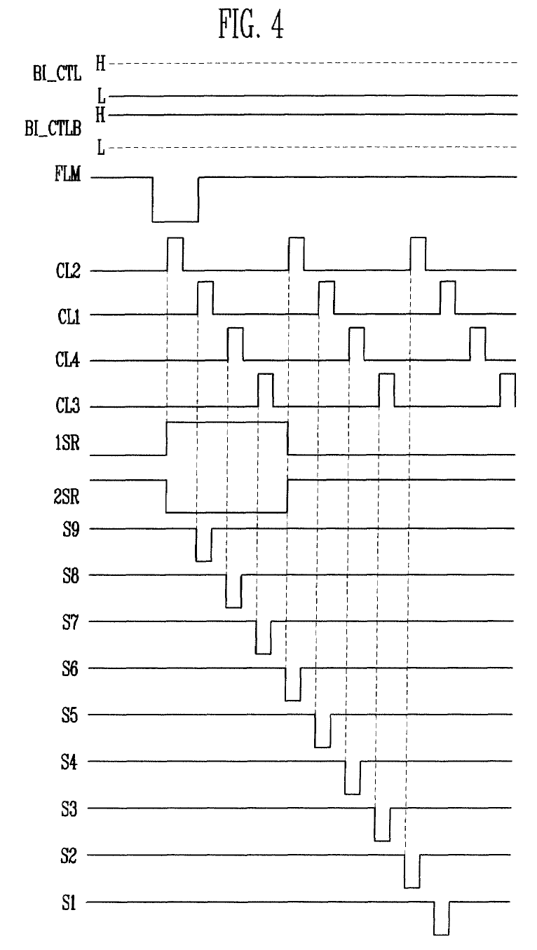

FIG. 4 is a timing chart illustrating a reverse operation of the scan driver shown in FIG. 2. Referring to FIG. 4, the scan driver 300 is operated by utilizing the first direction control signal BI_CTL, the second direction control signal BL_CTLB, the start pulse FLM, the first control signal CL1, the second control signal CL2, the third control signal CL3, and the fourth control signal CL4.

When the scan driver 300 is driven in a reverse direction, the first direction control signal BI_CTL becomes a low state, and the second direction control signal BI-CTLB becomes a high state. Therefore, the first transmission gate 311c of the transmission gate unit 310c becomes an off state, and the second transmission gate 312c becomes an on state. The start pulse FLM is transmitted to the latch unit 320c through the second transmission gate 312c. The second control signal CL2, the first control signal CL1, the fourth control signal CL4, and the third control signal CL3 are sequentially set high. The first control signal CL1, the second control signal CL2, the third control signal CL3, and the fourth control signal CL4 are controlled by a controller, for example, the controller 400 of FIG. 1.

When the second control signal CL2 becomes a high state, the third transmission gate 321c of the latch unit 320c becomes an on state, and the fourth transmission gate 322c becomes an off state. When the second control signal CL2 becomes a low state, the third transmission gate 321c becomes an off state, and the fourth transmission gate 322c becomes an on state.

Therefore, when the second control signal CL2 becomes a high state, when a low start pulse FLM reaches the latch unit 320c, the third transmission gate 321c becomes an on state, and the fourth transmission gate 322c becomes an off state. Therefore, the start pulse FLM is transmitted to the second inverter 324c through the third transmission gate 321c.

If the second control signal CL2 is a low state, the third transmission gate 321c becomes an off state, and the fourth transmission gate 322c becomes an on state. Therefore, the start pulse FLM is not transmitted to the latch unit 320c. Also, since the fourth transmission gate 322c becomes an on state, the input terminal of the second inverter 324c and the output terminal of the third inverter 325c are shorted by the fourth transmission gate 322c. That is, the input terminal of the second inverter 324c and the output terminal of the third inverter 325c have the same potential. In other words, when the second control signal CL2 becomes a high state, the start pulse FLM is transmitted to the latch unit 320c so that the second latch signal 2SR, in a low state, is output to the output terminal of the third inverter 325c. When the second control signal terminal CL2 becomes a low state, the output terminal of the third inverter 325c is coupled to the input terminal of the second inverter 324c by the fourth transmission gate 322c. Therefore, the second inverter 324c is transmitted with the second latch signal 2SR in a low state. The first latch signal 1SR, in a high state, is output through the second inverter 324c and the second latch signal 2SR, in a low state, is output through the third inverter 325c until a subsequent high second control signal CL2 is input to the latch unit 320c. Later, when a high second control signal CL2 is input to the latch unit 320c, the start pulse FLM is in a high state and is input to the input terminal of the second inverter 324c. Therefore, the first latch signal 1SR becomes a low state, and the second latch signal 2SR becomes high state.

The first latch signal 1SR output through the second inverter 324c of the latch unit 320c is transmitted to the output buffer unit 330c, and the second latch signal 2SR output through the third inverter 325c is transmitted to the transmission gate unit 310b in the second stage 300b.

The NAND gate of the ninth stage 333c of the output buffer unit 330c performs the NAND operation on the first latch signal 1SR and the first control signal CL1. Therefore, when both the first latch signal 1SR and the first control signal CL1 become a high state, a low ninth scan signal S9 is output. When at least one of the first latch signal 1SR and the first control signal CL1 becomes a low state, a high ninth scan signal S9 is output. The first latch signal 1SR maintains a high state by the operation of the latch unit 320c. Therefore, the output buffer unit 330c outputs a low ninth scan signal S9 when the first control signal CL1 is high. In other words, the pulse width of the ninth scan signal S9 is determined by the first control signal CL1.

The eighth output stage 332c and the seventh output stage 331c of the output buffer unit 330c operate similarly to the ninth operation terminal 333c. Here, the second control signal CL2, the first control signal CL1, the fourth control signal CL4, and the third control signal CL3 turn high sequentially. The first latch signal 1SR maintains a high state for a period when the second control signal CL2 turns high to when the second control signal CL2 turns high again. Therefore, after the first latch signal 1SR becomes a high state, the output buffer unit 330c first receives the first control signal CL1 in a high state, followed by a high fourth control signal CL4, and finally a high third control signal CL3.

Thus, the ninth output stage 333c transmits a low ninth scan signal S9 when the first latch signal 1SR is in a high state together with the first control signal terminal CL1 when it becomes a high state. The eighth output stage 332c transmits a low eighth scan signal S8 when the first latch signal 1SR is in a high state together with the fourth control signal terminal CL4 when it becomes a high state. The seventh output stage 331c transmits a low seventh scan signal S7 when the first latch signal 1SR is in a high state together with the third control signal terminal CL3 when it becomes a high state.

Therefore, the ninth scan signal S9 output from the ninth output stage 333c becomes a low state first, the eighth scan signal S8 output from the eighth output stage 332c becomes a low state second, and the seventh scan signal S7 output from the seventh output stage 331c becomes a low state third.

The second stage 300b and the first stage 300a operate similarly to the third stage 300c, to sequentially output the sixth scan signal S6, the fifth scan signal S5, the fourth scan signal S4, the third scan signal S3, the second scan signal S2, and the first scan signal S1. Therefore, the scan signals are output in a reverse direction.

While the present invention has been described in connection with certain exemplary embodiments, it is to be understood that the invention is not limited to the disclosed embodiments, but is instead intended to cover various modifications and equivalent arrangements included within the spirit and scope of the appended claims, and equivalent thereof.

What is claimed is:

1. A scan driver comprising a plurality of stages for outputting scan signals, wherein an n-1^{th} stage of the plurality of stages comprises:
a transmission gate unit for selectively outputting one of a second latch signal from an n-2^{th} stage of the plurality of stage or a second latch signal from an n^{th} stage of the plurality of stages in accordance with a first direction control signal and a second direction control signal;
a latch unit for outputting a first latch signal and a second latch signal by utilizing one of a plurality of control signals and the selected second latch signal, and for transmitting the second latch signal to the n-2^{th} stage and the n^{th} stage; and
an output buffer unit for outputting scan signals in accordance with other ones of the plurality of control signals and the first latch signal.

2. The scan driver as claimed in claim 1, wherein the transmission gate unit comprises:
a first transmission gate for transmitting the second latch signal from the n-2^{th} stage in accordance with the first direction control signal and the second direction control signal; and
a second transmission gate for transmitting the second latch signal from the n^{th} stage in accordance with the first direction control signal and the second direction control signal,
wherein the first transmission gate and the second transmission gate are on at different times.

3. The scan driver as claimed in claim 1, wherein the latch unit comprises:
a third transmission gate controlled by the one of the plurality of control signals, the third transmission gate for transmitting the selected second latch signal in accordance with the one of the plurality of control signals;
a fourth transmission gate controlled by the one of the plurality of control signals, the fourth transmission gate for transmitting the second latch signal to an output terminal of the third transmission gate;
a first inverter for inverting the one of the plurality of control signals and for transmitting the inverted one of the plurality of control signals to the third and fourth transmission gates;
a second inverter for inverting a signal output from the third transmission gate to generate the first latch signal; and
a third inverter for inverting a signal output from the second inverter to generate the second latch signal,
wherein the third transmission gate and the fourth transmission gate are on at different times.

4. The scan driver as claimed in claim 1, wherein the output buffer unit comprises at least one output stage, the at least one output stage comprising:
an operating unit for receiving one of the other ones of the plurality of control signals and the first latch signal;
a fourth inverter for inverting an output of the operating unit; and
a fifth inverter for inverting an output of the fourth inverter.

5. A scan driver comprising a plurality of stages for outputting scan signals, wherein an n-1^{th} stage of the plurality of stages comprises:
a transmission gate unit for selectively outputting one of a second latch signal from an n-2^{th} stage of the plurality of stages or a second latch signal from an n^{th} stage of the plurality of stages in accordance with a first direction control signal and a second direction control signal;
a latch unit for outputting a first latch signal and a second latch signal by utilizing a first control signal and the selected second latch signal, and for transmitting the second latch signal to the n-2^{th} stage and the n^{th} stage; and
an output buffer unit for outputting scan signals in accordance with additional control signals and the first latch signal.

6. The scan driver as claimed in claim 5, wherein the transmission gate unit comprises:
a first transmission gate for transmitting the second latch signal from the n-2^{th} stage in accordance with the first direction control signal and the second direction control signal; and
a second transmission gate for transmitting the second latch signal from the n^{th} stage in accordance with the first direction control signal and the second direction control signal,
wherein the first transmission gate and the second transmission gate are on at different times.

7. The scan driver as claimed in claim 5, wherein the latch unit comprises:
a third transmission gate controlled by the first control signal, the third transmission gate for transmitting the selected second latch signal in accordance with the first control signal;
a fourth transmission gate controlled by the first control signal, the fourth transmission gate for transmitting the second latch signal to an output terminal of the third transmission gate;
a first inverter for inverting the first control signal and for transmitting the inverted first control signal to the third and fourth transmission gates;
a second inverter for inverting a signal output from the third transmission gate to generate the first latch signal; and
a third inverter for inverting a signal output from the second inverter to generate the second latch signal,
wherein the third transmission gate and the fourth transmission gate are on at different times.

8. The scan driver as claimed in claim 5, wherein the output buffer unit comprises an output stage, the output stage comprising:
an operating unit for receiving one of the additional control signals and the first latch signal;
a fourth inverter for inverting an output of the operating unit; and
a fifth inverter for inverting an output of the fourth inverter.

9. The scan driver as claimed in claim 5, wherein the output buffer unit comprises a first output stage and a second output stage,
wherein the first output stage comprises:
a first operating unit for receiving one of the additional control signals and the first latch signal;
a fourth inverter for inverting an output of the first operating unit; and
a fifth inverter for inverting an output of the fourth inverter,
wherein the second output stage comprises:
a second operating unit for receiving another one of the additional control signals and the first latch signal;
a sixth inverter for inverting an output of the second operating unit; and
a seventh inverter for inverting an output of the sixth inverter.

10. An organic light emitting display device comprising:
a display unit for displaying images in accordance with data signals and scan signals;
a data driver for generating and outputting the data signals;
a scan driver for generating and outputting the scan signals; and
a controller for transmitting a plurality of control signals to the data driver and the scan driver,
wherein the scan driver comprises a plurality of stages for outputting the scan signals, and wherein an n-1^{th} stage of the plurality of stages comprises:
a transmission gate unit for selectively outputting one of a second latch signal from an n-2^{th} stage of the plurality of stages or a second latch signal from an n^{th} stage of the plurality of stages in accordance with a first direction control signal and a second direction control signal;
a latch unit for outputting a first latch signal and a second latch signal by utilizing one of the plurality of control signals and the selected second latch signal, and for transmitting the second latch signal to the n-2^{th} stage and the n^{th} stage; and
an output buffer unit for outputting scan signals in accordance with other ones of the plurality of control signals and the first latch signal.

11. The organic light emitting display device as claimed in claim 10, wherein the transmission gate unit comprises:
a first transmission gate for transmitting the second latch signal from the n-2^{th} stage in accordance with the first direction control signal and the second direction control signal; and
a second transmission gate for transmitting the second latch signal from the n^{th} stage in accordance with the first direction control signal and the second direction control signal,
wherein the first transmission gate and the second transmission gate are on at different times.

12. The organic light emitting display device as claimed in claim 10, wherein the latch unit comprises:
a third transmission gate controlled by the one of the plurality of control signals, the third transmission gate for transmitting the selected second latch signal in accordance with the one of the plurality of control signals;
a fourth transmission gate controlled by the one of the plurality of control signals, the fourth transmission gate for transmitting the second latch signal to an output terminal of the third transmission gate;
a first inverter for inverting the one of the plurality of control signals and for transmitting the inverted one of the plurality of control signals to the third and fourth transmission gates;
a second inverter for inverting a signal output from the third transmission gate to generate the first latch signal; and
a third inverter for inverting a signal output from the second inverter to generate the second latch signal,
wherein the third transmission gate and the fourth transmission gate are on at different times.

13. The organic light emitting display device as claimed in claim 10, wherein the output buffer unit comprises at least one output stage, the at least one output stage comprising:
an operating unit for receiving one of the other ones of the plurality of control signals and the first latch signal;
a fourth inverter for inverting an output of the operating unit; and
a fifth inverter for inverting an output of the fourth inverter.

14. An organic light emitting display device comprising:
a display unit for displaying images in accordance with data signals and scan signals;
a data driver for generating and outputting the data signals;
a scan driver for generating and outputting the scan signals; and
a controller for transmitting control signals to the data driver and the scan driver,
wherein the scan driver comprises a plurality of stages for outputting the scan signals, and wherein an n-1^{th} stage of the plurality of stages comprises:
a transmission gate unit for selectively outputting one of a second latch signal from an n-2^{th} stage of the plurality of stages or a second latch signal from an n^{th} stage of the plurality of stages in accordance with a first direction control signal and a second direction control signal;
a latch unit for outputting a first latch signal and a second latch signal by utilizing a first control signal and the selected second latch signal, and for transmitting the second latch signal to the n-2^{th} stage and the n^{th} stage; and
an output buffer unit for outputting scan signals in accordance with additional control signals and the first latch signal.

15. The organic light emitting display device as claimed in claim 14, wherein the transmission gate unit comprises:
a first transmission gate for transmitting the second latch signal from the n-2^{th} stage in accordance with the first direction control signal and the second direction control signal; and
a second transmission gate for transmitting the second latch signal from the n^{th} stage in accordance with the first direction control signal and the second direction control signal,
wherein the first transmission gate and the second transmission gate are on at different times.

16. The organic light emitting display device as claimed in claim 14, wherein the latch unit comprises:
a third transmission gate controlled by the first control signal, the third transmission gate for transmitting the selected second latch signal in accordance with the first control signal;
a fourth transmission gate controlled by the first control signal, the fourth transmission gate for transmitting the second latch signal to an output terminal of the third transmission gate;
a first inverter for inverting the first control signal and for transmitting the inverted first control signal to the third and fourth transmission gates;
a second inverter for inverting a signal output from the third transmission gate to generate the first latch signal; and
a third inverter for inverting a signal output from the second inverter to generate the second latch signal,
wherein the third transmission gate and the fourth transmission gate are on at different times.

17. The organic light emitting display device as claimed in claim 14, wherein the output buffer unit comprises an output stage, the output stage comprising:
an operating unit for receiving a one of the additional control signals and the first latch signal;
a fourth inverter for inverting an output of the operating unit; and
a fifth inverter for inverting an output of the fourth inverter.

18. The organic light emitting display device as claimed in claim 14, wherein the output buffer unit comprises a first output stage and a second output stage,
wherein the first output stage comprises:
a first operating unit for receiving a one of the additional control signals and the first latch signal;
a fourth inverter for inverting an output of the first operating unit; and
a fifth inverter for inverting an output of the fourth inverter,
wherein the second output stage comprises:
a second operating unit for receiving another one of the additional control signals and the first latch signal;
a sixth inverter for inverting an output of the second operating unit; and
a seventh inverter for inverting an output of the sixth inverter.
